(19) United States
(12) Patent Application Publication
(10) Pub. No.: US 2015/0089945 A1
(43) Pub. Date: Apr. 2, 2015

(54) HYBRID SOLAR AND FUEL-FIRED STEAM GENERATION SYSTEM AND METHOD

(71) Applicant: Chevron U.S.A., Inc., San Ramon, CA (US)

(72) Inventors: Craig Bradley Edward Wildman, San Ramon, CA (US); Emmanouil Kasseris, San Ramon, CA (US)

(73) Assignee: CHEVRON U.S.A., INC., San Ramon, CA (US)

(21) Appl. No.: 14/502,546

(22) Filed: Sep. 30, 2014

Related U.S. Application Data
(60) Provisional application No. 61/885,338, filed on Oct. 1, 2013.

(51) Int. Cl. F03G 6/00; F01K 11/04; E21B 43/24; F22B 1/00

(52) U.S. Cl. CPC F03G 6/003; F22B 1/006; F01K 11/04; E21B 43/24
USPC 60/641.8; 60/676; 166/57

(57) ABSTRACT

A method of generating steam using a combination of fuel and solar energy includes delivering liquid to a fuel-fired steam generator operating at least at partial load during a first time period, delivering liquid to a solar steam generator operating at least at partial load during a second time period, delivering saturated steam to a steam separator from at least one of the operating fuel-fired or solar steam generator, and delivering saturated vapor from the steam separator to a steam distribution system.

### CROSS-REFERENCE TO RELATED APPLICATIONS

This application claims priority under 35 U.S.C. §119(e) to U.S. Provisional Application No. 61/885,338, filed Oct. 1, 2013, which is incorporated herein by reference in its entirety.

### FIELD

Embodiments disclosed herein relate to solar and fuel-fired steam generation systems and methods.

### BACKGROUND AND SUMMARY

Solar thermal energy is a technology for harnessing solar energy to produce thermal energy (i.e., heat). Sunlight may be concentrated on tubing to generate steam at sufficient pressure and quality so that steam can be used for any variety of industrial applications, such as for thermal enhanced oil recovery. Because of the intermittent nature of sunlight, a solar steam system is well-suited to supplement a fuel-fired steam generation system.

FIG. 1 depicts a typical process flow diagram for a solar steam system incorporated with a fuel-fired steam system. Both the solar steam generator and fuel-fired steam generator draw feed water from a common tank and send steam at the same pressure and quality to a common steam distribution system. Liquid water enters the solar steam generator and leaves the solar steam generator as saturated steam with a steam quality of less than 100%. Steam is then sent to a steam separator which sends saturated vapor to the steam distribution system, and recirculates liquid water. At night, when the fuel-fired steam generator is used, the solar steam generator and the solar steam separator are filled with water. In mornings, during startup of the solar steam generator, the stored water is heated to produce steam prior to sending to the steam distribution network, however some liquid is also sent to the steam distribution network, where it is removed by steam traps along the line. This scenario represents a loss of heat. Also, two separators and two sets of pumps are used in the process in parallel, with each set operating at full load at a different time of day, which increases costs of steam generation systems.

What is needed then is a process and system for providing steam to a steam distribution system with both fossil fuel and solar energy systems operating together with reduced costs and greater efficiency.

In one aspect, embodiments disclosed herein relate to a method of generating steam using a combination of fuel and solar energy including delivering liquid to a fuel-fired steam generator operating at least at partial load during a first time period, delivering liquid to a solar steam generator operating at least at partial load during a second time period, delivering saturated steam to a steam separator from at least one of the operating fuel-fired or solar steam generator, and delivering saturated vapor from the steam separator to a steam distribution system.

In another aspect, embodiments disclosed herein relate to a steam generator system using a combination of fuel and solar energy including a fuel-fired steam generator operable at least at partial load during a first time period to generate saturated steam, a solar steam generator operable at least at partial load during a second time period to generate saturated steam, the solar steam generator further operable at about a beginning of the second time period to send heated water to the fuel-fired steam generator, and a steam separator common to at least one of the fuel-fired and solar steam generators, the steam separator configured to send saturated vapor to a steam distribution system.

### BRIEF DESCRIPTION OF THE DRAWINGS

The invention is illustrated in the accompanying drawings wherein,

FIG. 1 depicts a conventional process flow diagram for a solar steam system incorporated with a fuel-fired steam system;

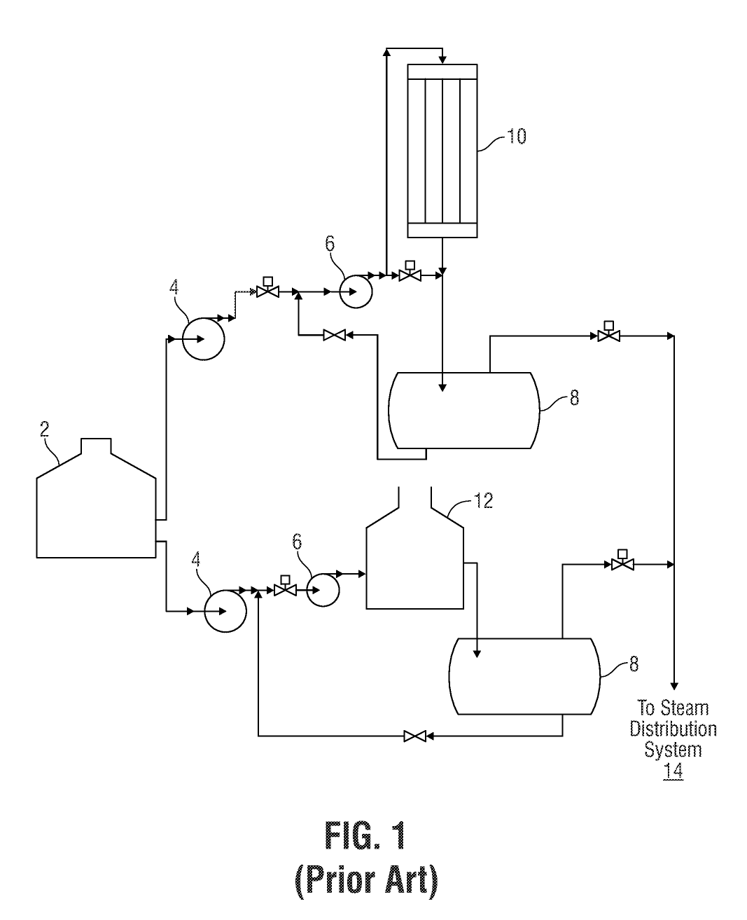

FIG. 2 depicts an embodiment of a process flow diagram whereby a solar steam generator and fuel-fired generator share a common separator, a common feed pump, and a common recirculation pump in accordance with one or more embodiments; and

FIG. 3 depicts an embodiment of a process flow diagram of FIG. 2 in a cogeneration arrangement.

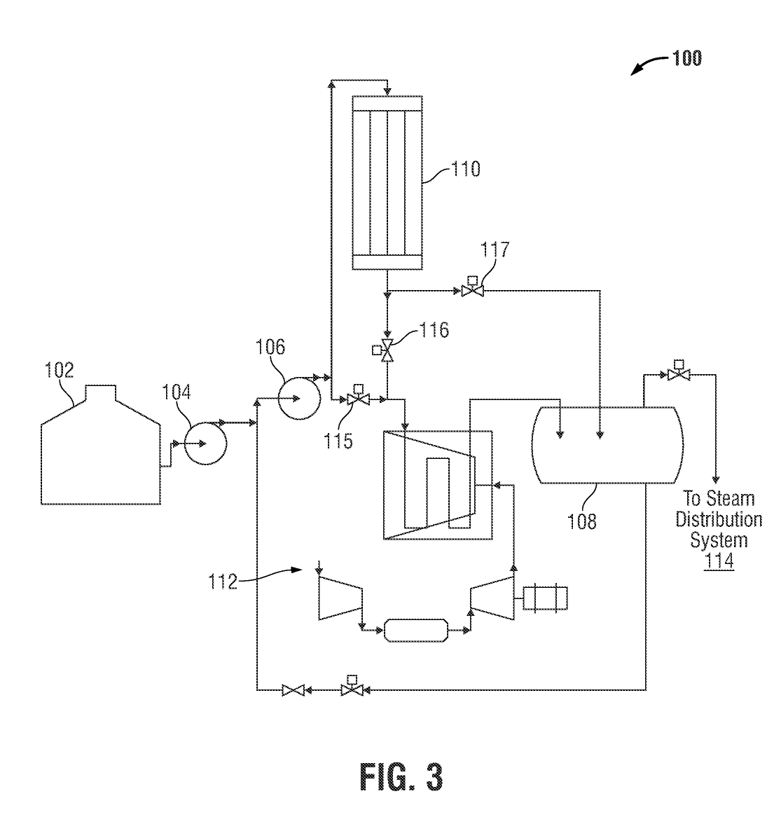

### DETAILED DESCRIPTION

A hybrid solar and fuel-fired steam generation system and process are disclosed. They system may include a solar steam generator and a fuel-fired steam generator using any available fuel. Fuel-fired generators may include a fossil or biomass fuel-fired steam generator, or hydrogen fuel-fired steam generator, or any other type of fuel-fired steam generator, or an array of multiple fuel-fired generators. For example, multiple fuel-fired generators may be arranged in parallel or series with respect to one another such that when load is reduced, one by one, each of the multiple fuel-fired generators may be turned off, or alternatively, each of the multiple fuel-fired generators may be turned down at once. Still further, the second steam generator may include a cogeneration plant. The cogeneration plant may use exhaust of a gas turbine to generate steam in one or more once-through heat recovery steam generators (HRSG). Or the HRSG may also employ supplementary duct firing. The duct firing rate or the gas turbine load may be varied as a means of varying the steam output of the HRSG. Those skilled in the art will be familiar with other steam generation devices as well. The solar steam generator may be a solar steam generator of any variety that uses mirrors to heat water to a temperature at which the water becomes saturated steam. The solar concentrator architecture may be a parabolic trough system, a linear Fresnel reflector system, an enclosed trough system, a central receiver system, or another method or system of concentrating light for a steam generator system.

The solar steam generator and fuel-fired steam generator share a common steam separator and one or more common feed and recirculation pumps. The steam separator may be any device for separating water droplets from steam. The feed pump and recirculation pump may be standard centrifugal pumps.

A control system may be implemented with the steam generation system to automatically control startup and operation of the fuel-fired steam generator and solar steam generator. The control system may use one or more process state variable inputs such as feed water temperature, flow rate, steam pressure quality and flow rate or liquid level in the steam separator and solar irradiance to control one or more actuators such as fuel firing rate, valve position and pump drive speed in order to achieve a desired overall steam production rate. For example, the control system may use feedback control based on a liquid level present in the steam separator. As another example, the control system may use steam quality measurements taken at an exit of the fuel-fired steam generator, or an inlet temperature of the fuel-fired steam generator (e.g., downstream of where the solar field feeds hot water to the steam generator inlet).

One or more components of the steam generation system such as pumps, valves, lines, etc. may be sized so that the fuel-fired steam generator, or one or more fuel-fired steam generators, is turned off completely once the solar steam generator reaches full load, or alternatively, one or more of the component may be sized so that the fuel-fired steam generator, or one or more fuel-fired steam generators, operates substantially all of the time but is reduced to a lower load when the solar steam generator is operated at full or near full load. The feed and recirculation pumps and steam separator may operate at or near full load constantly, whether the fuel-fired steam generators are at full load or the solar steam generator is at full load.

Methods of generating steam using a combination of fuel and solar energy include delivering liquid to a fuel-fired steam generator operating at partial or full load during a first time period, and delivering liquid to a solar steam generator operating at partial or full load during a second time period. Saturated steam is delivered from either of the fuel-fired or solar steam generator to a steam separator. Saturated vapor is delivered from the steam separator to a steam distribution system. At or near the beginning of the second time period, heated water exiting the solar steam generator may be delivered to the fuel-fired steam generator. Later during the second time period, water exiting the solar steam generator may be diverted to the steam separator when the water is near a saturation temperature. As used herein, the first period is generally during the night or night time hours between sunset and sunrise when the sun is below the horizon. The second period is generally during the day or daytime hours.

Steam produced by the steam generation system described herein may be utilized for a variety of purposes. As an example, the steam may be utilized in solar thermal enhanced oil recovery, or solar EOR, a technique applied to extract additional oil from maturing oil fields. The steam may be injected into an oil reservoir to reduce the viscosity, or thin, heavy crude oil thus facilitating its flow to the surface. However, other uses of the steam produced by the system will be understood by those skilled in the art.

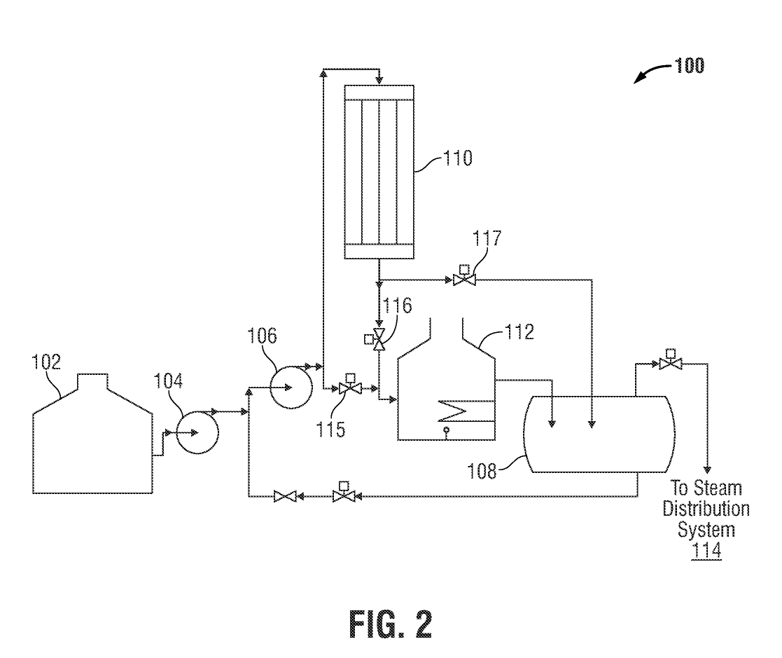

FIG. 2 illustrates a schematic of an embodiment of the system. The steam generation system includes a solar steam generator 110 and a fuel-fired steam generator 112. The solar steam generator 110 and fuel-fired steam generator 112 share a common steam separator 108, a common feed pump 104, and a common recirculation pump 106. Both the solar and fuel-fired steam generators draw feed water through a line from a common tank 102 and send steam at substantially the same pressure and quality from the steam separator 108 to a common steam distribution system 114. One or more valves 115, 116, 117 may be used to route liquid or steam within the steam generation system 100.

Methods of generating steam using the hybrid solar and fuel steam generation system 100 involves operating at full or partial load either the fuel-fired steam generator 112 during a first time period (e.g., night hours) or the solar steam generator 110 during a second time period (e.g., day hours). The feed pump 104, recirculation pump 106 and steam separator 108 may operate at or near full load constantly, regardless of whether the fuel-fired steam generator 112 or solar steam generator 110 are being operated. During night hours, liquid from the feed water tank 102 is pumped by feed pump 104 to the fuel-fired steam generator 112. Liquid enters the fuel-fired steam generator 112 and leaves the fuel-fired steam generator 112 as saturated steam. The fuel-fired steam generator 112 may deliver less than 100% quality saturated steam to the steam separator 108, which sends saturated vapor to the steam distribution system 114. For example, saturated steam quality may be at least about 40%, or at least about 45%, or at least about 50%, or at least about 55%, or at least about 60%, and up to about 70%, or up to about 75%, or up to about 80%, or up to about 85%, or up to about 90%, or up to about 95%. Liquid remaining in the steam separator 108 is recirculated back to the fuel-fired steam generator 112 by recirculation pump 106. During night hours, the solar steam generator 110 may not operate, but is filled with water from the feed tank 102.

At or near the beginning of the second time period (e.g., in the morning), the solar steam generator 110 initially begins to heat the water held therein overnight. The heated water may be sent to pre-heat the fuel-fired steam generator 112 (through a valve 116), thereby using the low-grade thermal energy provided by the heated water. When the water exiting the solar steam generator 110 is at or near a saturation temperature, the flow may then be diverted to the steam separator 108 (through a valve 117). Once the solar steam generator 110 produces an appreciable amount of steam, the fuel-fired steam generator 112 output may be reduced to allow a smooth transition to a state where the solar steam generator 110 is operating a full or near full load. For example, the fuel-fired steam generator 112 output may be reduced from a state where the fuel-fired steam generator 112 is operated at full load and solely delivers steam to the steam separator 108, to a state where both the fuel-fired steam generator 112 and solar steam generator 110 are operated at partial load and feed steam to the steam separator 108. Or alternatively, the fuel-fired generator 112 may be turned off to allow the solar steam generator 110 to operate at full or near full load and solely feed steam to the steam separator 112.

One or more embodiments relate to a steam generation system including a fuel-fired steam generator and a solar steam generator sharing a common steam separator, a common feed pump, and a common recirculation pump, wherein the fuel-fired and solar steam generators are operated simultaneously at partial or full load to maintain steam quality and flow rate delivered to a steam distribution system. One or more embodiments relate to a method of producing steam including operating a fuel-fired steam generator at partial or full load during a first period of time, operating a solar steam generator at partial or full load during a second period of time, the fuel-fired and solar steam generators delivering saturated steam to a common steam separator, and the steam separator delivering saturated vapor to a steam distribution system.

One or more embodiments relate to a method of producing steam including a solar steam generator delivering saturated steam to a common steam separator shared with a fuel-fired steam generator (or an array of multiple fuel-fired steam generators), and the steam separator delivering saturated vapor to a steam distribution system, or delivering preheated water as feed to the same fuel-fired steam generator (or array of multiple fuel-fired steam generators). One or more embodiments relates to using the steam separator to store thermal energy in the form of heated pressurized water, sometimes referred to as a “steam accumulator” or a “Ruths storage system.”

Advantageously, because feed and recirculation pumps and steam separator used are common to both the fuel-fired and solar steam generators, fewer components are required thereby reducing the overall system capital cost. Additionally, the steam generation system disclosed herein reduces heat loss during transient periods (e.g., startup) and improves operability over prior systems. For example, the steam separator is not filled with water overnight, therefore liquid water is not sent to the steam distribution system when the solar plant starts up. This reduces heat loss and the possibility of steam hammer events. Other means of avoiding sending liquid into the steam distribution system, such as additional recirculation loops or condensers, add cost, complexity and heat loss. Moreover, the steam generation system disclosed herein allows the steam separator to be used as a buffer to help smooth out cloud transients, that is, when clouds pass over the field, either the solar field output steam quality or its flow rate will drop, depending on details of the control system. In either case, the fuel-fired system may be used to stabilize the liquid level in the steam separator.

The claimed subject matter is not to be limited in scope by the specific embodiments described therein. Indeed, various modifications of one or more embodiments disclosed herein in addition to those described herein will become apparent to those skilled in the art from the foregoing descriptions. Such modifications are intended to fall within the scope of the appended claims.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±0.10 percent of the given numeric value provided such a deviation does not alter the end function or result of the value. Therefore, a value of about 1% can be construed to be a range from 0.9% to 1.1%.

What is claimed is:

1. A method of generating steam using a combination of fuel and solar energy, the method comprising:
delivering liquid to a fuel-fired steam generator operating at least at partial load during a first time period;
delivering liquid to a solar steam generator operating at least at partial load during a second time period;
delivering saturated steam to a steam separator from at least one of the operating fuel-fired or solar steam generator; and
delivering saturated vapor from the steam separator to a steam distribution system.

2. The method of claim 1, further comprising delivering heated water exiting the solar steam generator to the fuel-fired steam generator at about a beginning of the second time period.

3. The method of claim 2, further comprising diverting water exiting the solar steam generator to the steam separator when the water is near a saturation temperature during the second time period.

4. The method of claim 1, further comprising constantly operating a common feed pump, recirculation pump, and the steam separator at or near full load.

5. The method of claim 1, further comprising filling the solar steam generator with water during the first time period.

6. The method of claim 1, further comprising recirculating at least a portion of liquid remaining in the steam separator back to the fuel-fired steam generator.

7. The method of claim 1, further comprising operating the fuel-fired and solar steam generators simultaneously at substantially equal loads.

8. The method of claim 1, further comprising operating the fuel-fired and solar steam generators simultaneously at different loads.

9. The method of claim 1, further comprising transitioning the fuel-fired steam generator between full and partial loads and simultaneously transitioning the solar steam generator between full and partial loads.

10. A steam generator system using a combination of fuel and solar energy, the system comprising:
a fuel-fired steam generator operable at least at partial load during a first time period to generate saturated steam;
a solar steam generator operable at least at partial load during a second time period to generate saturated steam, the solar steam generator further operable at about a beginning of the second time period to send heated water to the fuel-fired steam generator; and
a steam separator common to at least one of the fuel-fired and solar steam generators, the steam separator configured to send saturated vapor to a steam distribution system.

11. The system of claim 10, further comprising a common feed tank and feed pump configured to deliver water to either the fuel-fired or solar steam generators.

12. The system of claim 10, wherein the fuel-fired steam generator comprises a cogeneration plant.

13. The system of claim 10, wherein the fuel-fired steam generator is configured to use fossil fuels, biomass, hydrogen, or combination thereof.

14. The system of claim 10, wherein the steam distribution system is utilized in enhanced oil recovery.

15. The system of claim 10, wherein the fuel-fired and solar steam generators are configured to operate simultaneously.

16. The system of claim 10, wherein the steam separator comprises a thermal energy storage system.
